(19) United States
(12) Patent Application Publication
(10) Pub. No.: US 2018/0137749 A1
(43) Pub. Date: May 17, 2018

(54) Personal Traffic Hazard Warning System

(71) Applicant: David Varga, Ewing, NJ (US)

(72) Inventor: David Varga, Ewing, NJ (US)

(21) Appl. No.: 15/100,927

(22) PCT Filed: May 31, 2016
(86) PCT No.: PCT/US16/35049

§ 371 Date: Jun. 1, 2016

Related U.S. Application Data
(60) Provisional application No. 62/168,603, filed on May 29, 2015.

(51) Int. Cl. G08G 1/005; A41D 13/01; G08B 21/04; G08B 6/00; G06F 3/01

(52) U.S. Cl. CPC G08G 1/005; A41D 13/01; G06F 3/011; G08B 6/00; G08B 21/0469

(57) ABSTRACT

A safety system is provided which uses sensors engaged to a person or their garments to measure light intensity or frequency or sound from a vehicle, to signal a processing circuit which determines a threat to a user. The system is configured to alert the user via haptic, visual or auditory alarms if measured lumens or sound correlates to a possible oncoming threat. Passive and active light-emitting surfaces on the garment can provide a warning or directional beacon to the vehicle.

### FIELD OF THE INVENTION

This application claims priority to U.S. Provisional Patent application Ser. No. 62/168603 filed on May 29, 2015, which is incorporated herein in its entirety by this reference thereto. The present device relates to safety equipment. More particularly, the disclosed device relates to safety equipment which employs light intensity and/or spectrum using one or a plurality of light sensors, which trigger tactile or haptic alerts which are communicated to the user if an increase in measured lumens, or a light spectrum of sensor-captured light, correlates to a possible oncoming threat to the user, and may concurrently initiate visual warnings to the oncoming motorist of user presence on the roadway.

### BACKGROUND OF THE INVENTION

People, whether road workers, pedestrians, bicyclists or motorcycle riders, are now more than ever before, working and traveling on or adjacent to America's highways and roads. In the case of road workers, it is a requirement of the job. In the case of pedestrians and riders, this is a consequence of both the desire to save on gas and vehicle costs, as well as the desire to exercise.

As road signs, vehicle speed limits and shoulder lane clearances between bike lanes and pedestrian walkways are present on many highways and roads. However, they are not universally employed as safety precautions for pedestrians, bicyclists, and motorcyclists. Road workers who must occupy road space or areas adjacent thereto are even less protected. Consequently, such individuals are very often at risk for road accidents from approaching vehicles which can cause injury and even death.

In addition, many roadways do not provide specific lanes or space for use by pedestrians or bicyclists, leaving those individuals to share space with passing vehicles. This proximity of individuals on or adjacent the roadway, coupled with the fact that may roadways are poorly lit, increases the potential for vehicle drivers not to see pedestrians and bicyclists they approach on the roadway. Even where motorcyclists occupy the roadway with proper lighting on their cycles, vehicle drivers using cell phones or computing devices or who might be tired, are inattentive and even less inclined to ascertain the presence of workers, pedestrians, and vehicles smaller then their own car or truck traveling or positioned on or adjacent the roadway in front of them.

As a consequence, especially at dusk and in evening hours, pedestrians, cyclists, road workers, and motorcyclists are at extreme risk of being struck by an oncoming vehicle. Vehicle drivers in addition to being handicapped by poor visibility in this time frame, are also, as noted, guilty of being inattentive. Studies continually show that the risk of such inattention is logarithmically increased where the vehicle drivers are texting, dialing a phone, reading email, or even talking on a cellular phone call.

For this reason, many pedestrians, cyclists, road workers, and other individuals, sharing road space with vehicles, have attempted to provide viewable signals to vehicle drivers of their concurrent presence on or adjacent a roadway. Such devices include wearable light generating components such as tail lights, headlamps, or other lights, and light reflective devices which reflect light generated from approaching vehicles, back toward those vehicles.

These conventional visible signaling devices are available to pedestrians, cyclists, and road workers to increase their visibility and thereby warn vehicle drivers of their proximity to the oncoming vehicle approaching them. However, in spite of the large number of passive and active light projecting and reflecting devices available to help warn oncoming drivers, there are few, if any, devices currently available configured to provide an alert to the pedestrians or bicyclists, or others occupying the roadway or areas proximate thereto, of the threat of an oncoming vehicle. Further, such devices generally do not communicate a visually discernable warning to approaching drivers of the presence of such pedestrians or riders, nor a visually discernable directional beacon to avoid them.

This is a significant shortfall in safety for such because most road workers, pedestrians, cyclists, motorcyclists, and others who are on or adjacent roadways, frequently face away from the oncoming vehicle threat. This is because riders generally travel in the same direction of oncoming traffic, as do runners, and pedestrians. Road workers are required to assume all types of positioning and are generally focusing on their work or task rather than oncoming vehicles.

Consequently, the eyesight of these individuals is gazing in a direction away from oncoming vehicles, and they, thus, cannot visually discern oncoming vehicles nor their proximity in time to react and move to safety. While such individuals might hear the oncoming vehicle approaching, since the speed of sound is well short of the speed of light, this warning if heard, will generally be too late. Thus, the individual hearing and realizing the approach of a vehicle will turn and see it at a time when it may be too late to avoid impact and resulting serious injury.

As such, there is an unmet need for an alert system which can automatically alert road workers, pedestrians, bicyclists, and even motorcyclists, of the potential threat of oncoming or approaching vehicle traffic. Such a system should be adapted to communicate such an alert in time to allow the user to physically react to move out of the way or at least minimize the threat of an impact.

To maximize such a warning, such a device could employ light emitted from an approaching vehicle as the trigger to issue a user alert either by employment of a light sensor or photometer which measures the light intensity and/or spectrum, to provide data or signals to cause a warning to be communicated to the user of an oncoming vehicle threat. Additionally, such a system should concurrently communicate a visually discernable warning to the oncoming motorist, of the presence of the pedestrian, worker, or rider. Still further, such a device and method should provide the user with preferably a tactile or haptic warning to their person since audible and visible warnings are easily overcome by road noise and ambient light on a roadway.

The forgoing examples of related art and limitation related therewith are intended to be illustrative and not exclusive, and they do not imply any limitations on the invention described and claimed herein. Various limitations of the related art will become apparent to those skilled in the art upon a reading and understanding of the specification below and the accompanying drawings.

### OBJECTS OF THE INVENTION

It is an object of the present invention to provide a device and method for a system adapted to measure light intensity through one or a combination of light sensors, spectrum sensors, and light meters, and employ signals from such to determine and cause a communication of alerts to the user if predetermined parameters have been met which correlate to a potential oncoming threat.

It is an additional object of the invention to provide such a system using such sensors for light or sound, which is portable and wearable.

It is a further object of this invention to provide the user at least a tactile or haptic alert as to the approach of a potential oncoming vehicle threat to insure proper communication in the noisy environment on or adjacent a roadway.

It is yet another object of this invention to concurrently communicate visually discernable alerts to oncoming drivers of the presence of a rider or worker or pedestrian in or adjacent the path of their vehicle.

These and other objects, features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### SUMMARY OF THE INVENTION

In accordance with the purposes of the present invention, as embodied and broadly described herein, the present invention provides a system configured to detect potential hazards to riders, pedestrians, and workers, caused by the approach of vehicles to their proximity. The system is especially valuable for safety when employed in dim environments and to provide users one or more perceptible warnings of such in advance of the vehicle becoming overly proximate to the user.

In one preferred mode of the device and system, one or more wearable light meters or light sensors, which measure the direction, luminous intensity of light or the spectrum, are configured for temporary or permanent engagement on or over clothing or accessories of users. Such may be included as part of shirts, vests, wristbands, helmet headbands, belts, or other user-wearable configurations.

The light sensors are adapted to communicate electrical signals or data concerning light received which has been transmitted by an oncoming vehicle to a processor circuit such as one or a combination of a computing component or processing circuit, or switch. The processor circuit or switch is configured to analyze the communicated signal or data transmitted by the one or plurality of light sensors, such as by measuring received lumen values or light frequency, to determine a source of the communicated light, a proximity and/or incoming direction, and whether the ascertained source of the measured light sensed, is a current or potential risk to the user. A plurality of sensors for sound can also yield varying electronic signals indicative of incoming direction of a vehicle.

The switch or processing circuit may employ a microprocessor having electronic memory for running software adapted to calculate such a proximity and issue a warning, or other switching configured to allow a preprogrammed or user-adjustable luminosity threshold, to be input at levels which will cause an alarm to be communicated to the user. This preprogrammed or user input of threshold levels may be provided to prevent false positives and resulting threat alerts by differentiating between low intensity, ambient, and stationary work-lights, or light color and frequency, and the high intensity of potential oncoming headlights.

Additionally, threat detection algorithms running as part of the onboard software running in electronics memory or programmed into the processing circuit or switch, which are adapted to utilize signals generated by the light sensors based on their respective acute or obtuse angle of view, can be employed to increase alert specificity and further reduce false-positives. Further, sound sensors such as directional microphones may be included which are adapted to listen for oncoming vehicle noises and communicate electronic signals, the increasing intensity thereof over time, providing an electronic signal to discern a rate of approach of a vehicle.

With regard to a light sensing algorithm or software which will run in electronic memory connected to a powered microprocessor, one such algorithm could calculate the derivative of the lumen-time series to determine a light intensification rate, and potentially differentiate between vehicle headlights, and the slow rotation of the user's body into the oncoming light. The sensors would sense “white” light which is required by law for forward facing lighting in vehicles such as for example light between 1500 k and 7500 k. Correlation of the lumen-time differential measurements among a known geometric array of light sensors can additionally be employed to determine the relative angular velocity of the light source or the user. Further, if sound sensors are employed, the decibel increase as a function of time may be employed to discern a closing rate of the approaching vehicle. Still further, using one, or better yet, a plurality of light sensors adapted to calculate a position of the oncoming vehicle lights, relative to the user or wearer, a visual signal on the body of the user can be triggered to warn the oncoming driver of their presence and to provide directional signals such as individual or sequential arrows, to avoid them. In this mode one of the light sensors would be more aligned with the oncoming light than the other, and an angle of the approaching vehicle to the user can be determined by the stronger electronic signal from the sensor more aligned with the oncoming light versus the weaker electronic signal from the non-aligned light sensor.

If the algorithm determines that the light source sensed by the sensors or the sound sensed, or combinations of data signals therefrom, yield a potential threat to the user from an approaching vehicle, the processing circuit such as the microprocessor and software running in electronic memory or switch will trigger one or more of the alarms to alert the user. In one mode of the device, the user can employ one or a plurality of wearable alarms which in communication with their person through being temporarily or permanently attached into one or a combination of clothing or accessories including but not limited to: shirts, vests, wristbands, helmet headbands or belts or other wearable components to position the alarm on the person of the user.

Each alarm may utilize one or a combination of user alerting means including but not limited to communicating vibrations, a shock, a sound or flashing lights. However, vibration communicated to the body of the user is especially preferred in that it is instantaneously communicated electrically to the body of the user, and not prone to being ignored or missed in the noisy and illuminated venue of a user on or adjacent a highway or roadway.

Additionally, a user may wear on their person one or a plurality of more diametrically placed light sensors and alarms, preferably on the back and front of the person of the user. The device in this preferred mode can use electronic signals from the sensors to determine and communicate the direction of the potential threat from both the front and rear of the user.

Employing the device herein, the light sensors positioned on the person of the user, either by inclusion in clothing or attached thereto, may in one mode receive the light intensity of ambient and oncoming sources such as headlights, and transmit data or an electronic signal correlating to a luminosity value, to the computerized processing circuit or switch. If the signal meets or exceeds a predetermined level, based on software or onboard programmed algorithms which determine whether the light sensed light source is or is not a potential threat, a tactile, haptic, visual or other method of warning may be communicated to the user.

The system may also ascertain a direction of approach of the vehicle generating the sensed oncoming light from the known location of each light sensor. Should a potential threat to the user be found, the processor circuit or switch will trigger one or more alarms to be sensed by the user of the oncoming threat, and may also initiate a visually discernable warning to the oncoming driver in the form of illumination of the wearer of the device. As noted, one light sensor may be able to determine such a direction of incoming light from headlights, and two or more such light sensors spaced horizontally from each other, will generate differing signals depending on the angle of the incoming light striking each sensor, and the differing output signals can be used to determine incoming direction of the vehicle.

To warn oncoming drivers the user may wear reflective or electrically illuminated surfaces. Examples of such include 3M SCOTCHLITE Reflective tape which will reflect headlights, and for an active beacon 3M THINFLEX LED Tape Lights which can be energized by an onboard battery to illuminate and to also form a directional warning to avoid the wearer.

In another mode of the device, the light sensors can be mounted on the ground, tripod or platform for more accurate oncoming threat direction detection. A wireless transmitter would communicate signals to the body-worn devices on the users to initiate warnings to them and/or visually discernable warnings to the oncoming driver.

Such might be employed where one user or many users are adjacent or on the roadway or in a small area on or adjacent a roadside or highway for extended periods of time. This mode of the device reduces the need for any algorithms necessary to accommodate for user and light meter translation, and allows the device to employ larger and more sensitive light sensors for increased light measurement accuracy. This configuration, can only alert users to the direction of the potential oncoming with additional user location communications from individual users and directional sensors discerning the direction of the oncoming vehicle.

Employing this stationary mode of the device and system herein, light intensity measured by a single or multiple stationary light sensors is conveyed to the computing device running software in electronic memory of a processing circuit or to a switch, which if above the noted threshold, will trigger one or a plurality of alarms worn by one or group of local users. In this stationary mode, the alarms worn on the person of the users would be in wireless communication with a transceiver operatively connected to the computing device of the processing circuit connected to the light sensors, or if also employed, sound sensors. Such will allow instantaneous communication of an alarm which may be sensed by all users proximate to the stationary device giving all time to react. Such may also cause the triggering of onboard lighting on each proximate user to provide a visually discernable warning or directional beacon to the oncoming driver.

In either mode, whether the device components are integrated or separated, electronic communication between the light sensors, processing circuit or switch, and the alarms can be performed by one or a combination of electronic signal transmission means from a group of such transmission means including wires, fiber optic cables, or wireless transmission such as bluetooth, wifi or cellular reception.

Additionally, the device components in either preferred mode can be powered by one or a combination of electric power sources from a group including batteries, fuel cells, solar power or an external power supply.

With respect to the above description, before explaining at least one preferred embodiment of the herein disclosed invention in detail, it is to be understood that the invention is not limited in its application to the details of construction and to the arrangement of the components in the following description or illustrated in the drawings. The device herein described and disclosed in the various modes and combinations is also capable of other embodiments and of being practiced and carried out in various ways which will be obvious to those skilled in the art. Any such alternative configuration as would occur to those skilled in the art is considered within the scope of this patent. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other powder and pill storage and dispensing products for carrying out the several purposes of the present disclosed device. It is important, therefore, that the claims be regarded as including such equivalent construction and methodology insofar as they do not depart from the spirit and scope of the present invention.

### BRIEF DESCRIPTION OF DRAWING FIGURES

The accompanying drawings, which are incorporated herein and form a part of the specification, illustrate some, but not the only nor exclusive examples of embodiments and/or features of the disclosed device. It is intended that the embodiments and figures disclosed herein are to be considered illustrative of the invention herein, rather than limiting in any fashion. In the drawings:

FIG. 1 depicts a block diagram of a mode of operation of the device and system herein.

FIG. 2 shows a front view of a person employing various modes of sensors of the device and system herein.

FIG. 3 depicts a bracelet or armband adapted with a buzzer or other tactile or haptic warning component imparting a warning to the skin or person of the user.

FIG. 4 shows a belt mode of the device showing the processing circuit connected to passive or active light strips which provide visual warnings to oncoming drivers.

FIG. 5 shows a front view of a user wearing a garment having a light-emitting surface thereon configured to form a directional beacon for oncoming motorists showing such emitting a left direction relative to the user based on signal inputs from two horizontally spaced sensors.

FIG. 6 shows a rear view of the device as in FIG. 5, showing the directional beacon from the light-emitting surface directing toward the left of the user.

FIG. 7 shows the device herein having a light-emitting surface which is formed to emit light sequentially using sections of the surface which illuminate sequentially.

FIG. 8 depicts the device of FIG. 7 from the rear of the garment worn by the user having the light-emitting surface.

FIG. 9 depicts an example of a plurality of users such as a workman adjacent a road, where the sensing components engaged to a wireless-enabled processing circuit concurrently causes directional illumination of the garments of the workman and which may also activate the tactile or noise alarms of each wearer as to the incoming traffic.

### DETAILED DESCRIPTION OF THE INVENTION

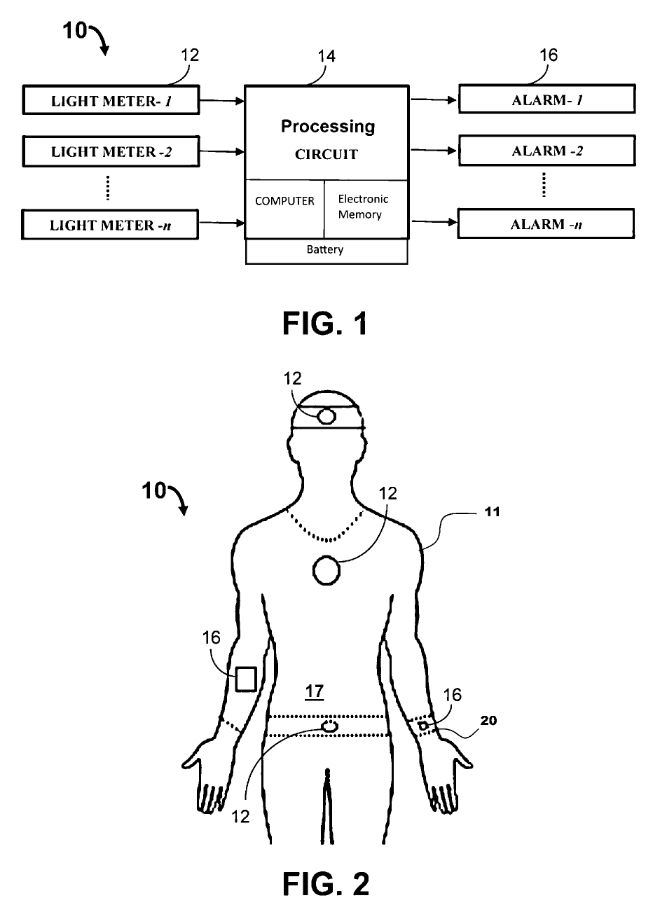

Now referring to the drawings in FIGS. 1-9, wherein similar components are identified by like reference numerals, there is seen in FIG. 1, a conceptual flow chart or block diagram of the operative components of the device 10 configured to be in operative communication with sensors 12 such as light meters, microphones, or other light sensors, and user or driver alarms 16, and adapted to detect potential traffic hazards in dark and dim environments and alert one or a combination of the user 11 and the approaching driver.

In the one preferred mode of the device 10 shown as in operation in FIG. 1, and graphically shown engaged with a user 11 in FIG. 2, one or a plurality of wearable sensors 12, which are adapted to measure the luminous intensity of emitted light contacting a sensor 12, or the light color or frequency contacting the sensor 12, or sound, are temporarily or permanently engaged with one or a combination of garments or clothing or accessories worn by a user 11, and in operative engagement with a processing circuit 14 also so engaged. Such worn garments, clothing or accessories, may include one or a combination of clothing from a group including shirts, pants, vests, wristbands, straps, headbands, helmets, hats, or belts.

Signals generated by one or a plurality of such sensors 12 are operatively communicated to the processing circuit 14 such as a computer microprocessor having electronic memory and a power source such as a battery which may be formed on a circuit board, or to a switch. So communicated, the signals from one or more sensors 12 communicated as a signal to the processing circuit 12 using software running in electronic memory or other means for such, are discerned and analyzed for the communicated measured lumen values from each sensor 12, or sound values, to determine whether the source of the measured light or sound if sensed, indicates a direction of an oncoming vehicle which is a potential risk to the user 11 in their present location. As noted, sensors 12 may also be adapted to receive sound, and generate a sound signal to the processing circuit 14.

The processing circuit 14, as noted, may employ software adapted to use a preprogrammed or user-adjustable threshold for the level of signal received for luminosity, light intensity, light frequency, sound, or combinations thereof, to prevent issuance of false positive threat alerts by differentiating between low intensity, ambient, stationary work-lights and the high intensity of potential oncoming headlights, or the light frequencies of light generated by vehicles versus roadside sources, and when proper, communicate one or a plurality of a tactile or sonic or visual warnings to the user 11, and/or a visible warning or directional beacon to the approaching driver.

Using software running on the processing circuit 14 adapted to employ threat detection algorithms programmed into the processing circuit 14 or software running thereon, the signals communicated from the sensors 12, such as light sensors or sound sensors, and known positioning thereof, at an acute or obtuse angle of view, can be employed to increase alert specificity and further reduce false-positives.

For example, such an algorithm can calculate the derivative of the lumen-time series, using the light intensity signal over a duration of time, to determine a light intensification rate. This will allow the device 10 to differentiate between a speeding car's oncoming headlights, and a slow rotation of the user's body into or toward the oncoming light. Correlation of the lumen-time differential measurements among a known geometric array of light sensors 12 and their known positions on the front or rear of the user 11, can additionally be employed to determine the relative angular velocity of the incoming light source relative to the position of the user 11.

One of a combination of alarms can be communicated to the user 11, from a group including, a haptic or tactile alarm, for example, a buzzer 24 felt by the user 11, or a sonic alarm from a loudspeaker or sound generator heard by the user 11, or light from a visual alarm in position to be seen by the user 11, as to the danger of the oncoming vehicle. The sonic alarm could be in the form of an earphone, beeper, or buzzer, (not shown but well known) and the visual alarm could be provided by an LED or other light generating component also not shown, but well know.

The processing circuit 14 having electronic memory and a microprocessor or computing component, using software running thereon, may employ software adapted to measure the incoming electronic signals from the one or more sensors 12, and compare such to a memory stored onboard database of such signals and thresholds, which if surpassed would cause the issuance of one of the alarms to the user 11 or as noted herein, a viable beacon or warning to the approaching driver. Such thresholds may be included in the stored database of signal types and levels, or can be input by the user 11 using a connection to the processing circuit 14 such as a smartphone or computer in a wired or wireless communication therewith. Updates can also be communicated in this manner.

If the algorithm or the running onboard software determine that the signals communicated from one or more sensors 12 reach or pass the determined threshold for such, or when compared for strength show an incoming angle of an oncoming vehicle generating the source of the sensed light or sound is a potential threat, the processing circuit 14 using software or onboard switching, will trigger the energizing and communication of one or more connected sonic, light, or haptic alarms 16, to the user 11, and as noted, may also initiate visibly discernable warnings or directional beacons to the oncoming driver using light-emitting areas 38 positioned on the user-worn garments 17.

In one preferred mode of the device 10, such as shown in the graphic depictions in FIG. 2, the user 11 can be equipped with one or several wearable alarms 16 which are worn by the user 11 or engaged with clothing worn on their body or person. The alarms 16 may be temporarily or permanently engaged with any one or a combination of clothing or accessories as noted above. Or the alarm may simply be engaged with a belt or strap such as in FIG. 4, to the person of the user 11 such as a bracelet or wristwatch adapted to impart a tactile alarm to the person of the user 11, such as a buzzer or mild electric shock. The alarm 16 can provide the user 11 one or a combination of discernable alerts using one or a combination of user-discernable alerts, from a group including vibrations, tapping, electric shock, sound, or flashing lights.

Additionally, if the user 11 wears two or more diametrically placed sets of sensors 12 for light or sound, and correlating alarms 16, preferably on the back and front of the person of the user 11, the device 10 can determine and communicate an approaching direction of the potential threat, and alert the user 11 of that direction by activating the alarm 16 correlating to the sensor 12 or sensors 12, communicating the signal. For example, a single vibration, light, or buzzer for a vehicle approaching from the front of the user 11 and a plurality of such for a vehicle approaching from the rear.

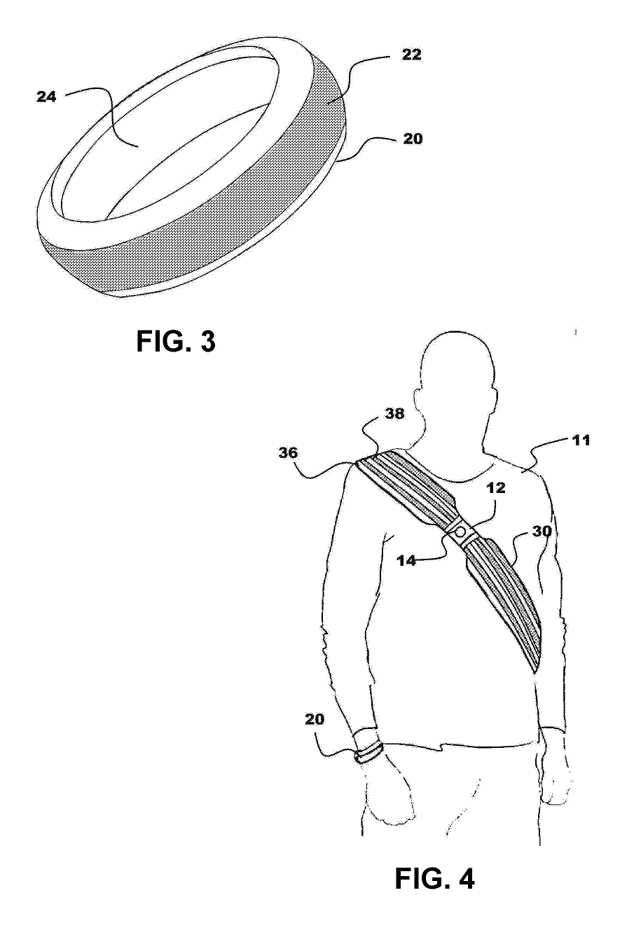

Employing the device 10 one preferred mode herein, the worn sensors 12 such as for light, measure the light intensity of ambient and oncoming sources, and/or the light color or frequency of an approaching light source, and emit an electronic signal corresponding to a luminosity value, to the processing circuit 14. Using the aforementioned software or algorithms or both, running on the processing circuit 14, the device 10 can determine whether the signal or signals from sensors 12 correlating to a light source, reach a threshold level determined to be a potential threat based on the programmed algorithm's results, or software processing of the levels of received signals relative to such signal levels determined to be threats and stored in onboard databases. If a potential threat to the user 11 is determined, the processing circuit 14 triggers or energizes one or more of the alarms 16 which may be located directionally relative to the incoming threat. Such alarms 16 as noted may be tactile, sonic or visual to the user 11, and may include concurrent activation of visually discernable alarms on the person of the user 11, which may be seen by the oncoming driver of the vehicle, such as noted in FIGS. 3-9.

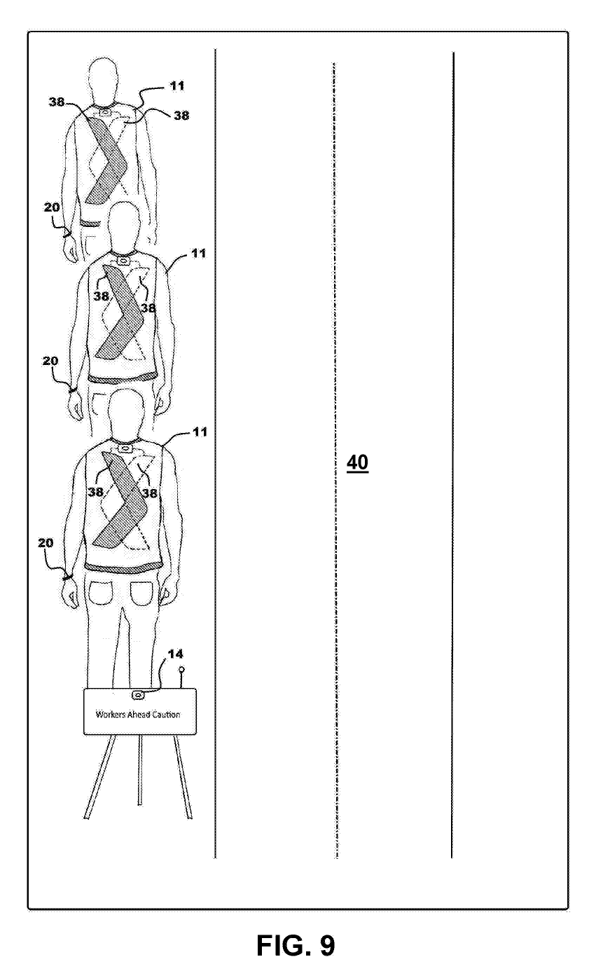

In another mode of the device 10 on operation thereof, the sensors 12 for light or sound, can be mounted in a fixed position such as on the ground, on a tripod or engaged with a stationary or moving platform, for more accurate oncoming threat direction detection, for example as shown in FIG. 9. This mode of the device 10 reduces the need for algorithms or other software calculation necessary to accommodate for user 11 and sensor 12 translation and movement since the sensors 12 are in front of the adjacent user 11. Further, such allows the device 10 to employ larger and more sensitive sensors 12 for increased light measurement accuracy, or sonic or other sensor-perceived measurements of oncoming vehicles. As noted, sensors 12 may also be included to measure sound in both frequency and decibels and Doppler characteristics, to ascertain an approach rate of a vehicle and used with sensors 12 configured to sense light.

This configuration, in a fixed position on a mount however, can only alert users 11 to the direction of the potential oncoming threat with additional user location and directional sensors. Employing this stationary mode of the device 10 and system herein, light intensity measured by a single or multiple stationary sensors 12, and/or sound from sensors 12, is communicated as an electronic signal to the processing circuit 14. If the signals received are equal to or exceed established threshold levels for the communicated signal or data, the processing circuit 14 triggers one or more alarms 16 worn by one or group of users 11 proximate to the mounting site for the device 10. Such signals to activate user-worn alarms 14 may be by wireless communication such as bluetooth, light signals, WiFi, cellular, or other wireless communications protocols.

In either mode, whether the device components are integrated or separated, communication between the sensors 12 for light, and sensors 12 for sound if employed, and the processing circuit 14 and the alarms 16 can be performed by one or a combination of electronic signal transmission means including but not limited to wires, fiber optic cables, or by wireless communication such as bluetooth, WiFi or cellular reception.

FIG. 3 depicts a bracelet 20 or armband adapted for wearing on the arm of a user 11. The bracelet 20 may be equipped with a tactile warning for the user 11 such as a buzzer or other tactile warning component 24 imparting a warning to the skin or person of the user 11. Further, the bracelet 20 may also be equipped with a light generating warning component 22 such as LEDs or light emitting fabric such as THINFLEX from 3M corporation to emit continuous or sequential light. An onboard battery and switches (not shown but well known) would be held on the interior of the bracelet 22 to activate the tactile warning component 24 and/or the light generating warning component 22.

Shown in FIG. 4, is a belt 30 mode of the device 10 showing the processing circuit 14 and one or more sensors 12 positioned on one or more of a front-facing and rear-facing portion of the belt. Preferably sensors 12 for light and/or sound are positioned on both the front facing surface of the belt 30 as in FIG. 4, and a rear facing surface of the belt 30 on the back of the user 11 (not shown but the same or similar to front).

In operative contact with the processing circuit 14 and an electric power source such as a battery, are connected with light emitting surfaces 38. Such may be one or both of a passive light emitting-surface 36 which reflects incoming light from the vehicle, or active light emitting surface 38 such as THINFLEX from 3M, which when powered by electric power from the battery, will emit light visible to oncoming drivers as a warning of the presence of the user 11. A combination of both passive and active light-emitting surfaces 38 can also be used to insure the user 11 is seen should power for the active surfaces be unavailable.

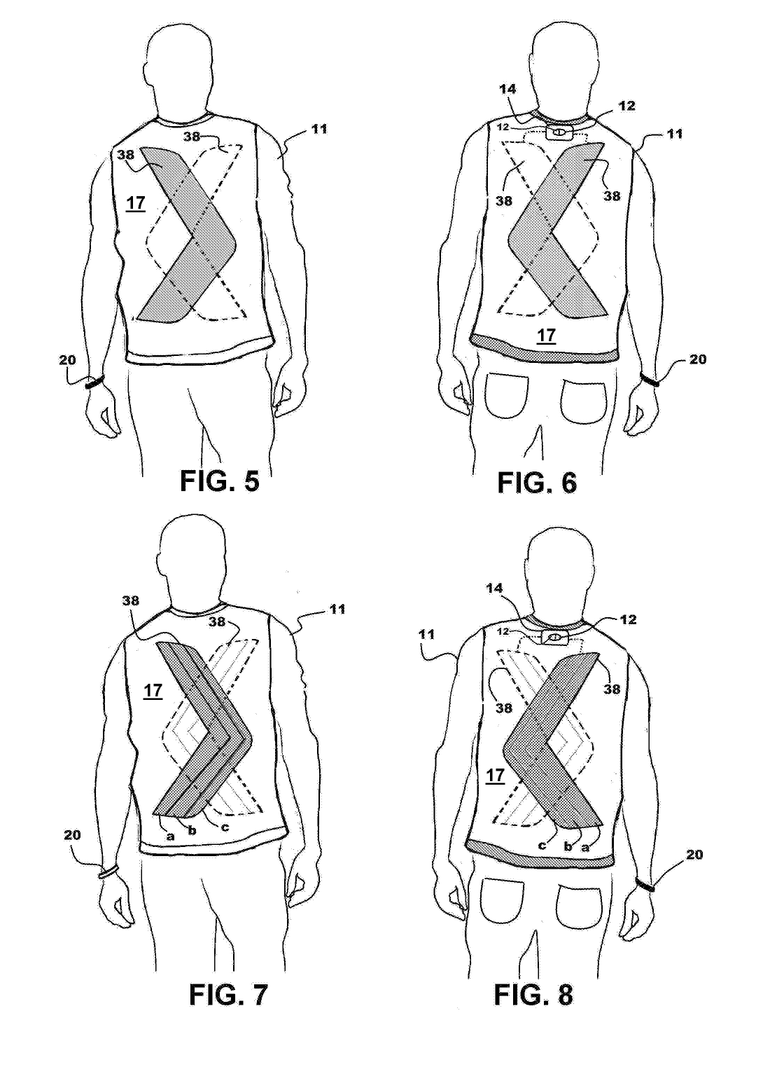

In FIGS. 5-6 is shown frontal and rear views of a user 11 wearing a garment 17 having an active light-emitting surface 38 thereon, which may be connected to the power of an onboard battery using signal and switching provided in the aforementioned manner from a processing circuit 14 connected to a plurality of horizontally spaced sensors 12 such as in FIG. 6. As shown, the garment 17 includes the active light-emitting surface 38 formed in two directional arrows, where one of the two directional arrows is energized to emit light by the processing circuit 14 based on incoming signals from one or more sensors 12 and points a direction for the vehicle to proceed and avoid the user.

In this mode of the device 10, the processing circuit 14, will ascertain which side of the user 11 on which the vehicle is traveling based on differing electronic signals from the two sensors 12, and activate the directional beacon formed as an arrow by one of the two active light-emitting surfaces 38, as a visual warning and directional beacon, as to which direction the driver should travel to avoid the user 11. As depicted this is an arrow showing to go left of the user 11.

FIGS. 7-8 show the device 10 herein having a light-emitting surface 38 which is formed by smaller separated light-emitting surfaces a, b, and c, which will emit light sequentially when activated and energized by the processing circuit 14, in a direction from one side toward the other size of the formed beacon. This provides the oncoming driver with a sequentially illuminated light-emitting surface 38, toward the direction desired of the oncoming driver to avoid the user 11. As in the mode of FIGS. 5-6, the sensor 12 or plurality of horizontally spaced sensors 12, can yield differing input signals to the processing circuit 14, to allow it to ascertain an incoming direction of the oncoming vehicle and illuminate the light-emitting surface as a warning, and in this case as a sequentially illuminated beacon to the oncoming driver to communicate a direction for that driver to avoid the user 11.

Finally, as noted above, FIG. 9 depicts an example of a plurality of users 11, such as workmen adjacent a road 40, where the sensing components 12 are operatively engaged to a wireless-enabled processing circuit 14. In this mode as noted, the processing circuit 14 can wirelessly activate the warnings to the users 11 such as by activating the bracelets 20. Concurrently, the light-emitting surfaces 38 on each user 11 can be activated to illuminate and provide the noted directional illumination or beacon to the driver on each of the garments of each workman, to provide a directional beacon for travel to the oncoming driver to stay on the road 40 and avoid the users 11 shown here as workers.

As noted, any of the different configurations and components can be employed with any other configuration or component shown and described herein. Additionally, while the present invention has been described herein with reference to particular embodiments thereof and steps in the method of production, a latitude of modifications, various changes and substitutions are intended in the foregoing disclosures, it will be appreciated that in some instance some features, or configurations, or steps in formation of the invention could be employed without a corresponding use of other features without departing from the scope of the invention as set forth in the following claims. All such changes, alternations and modifications as would occur to those skilled in the art are considered to be within the scope of this invention as broadly defined in the appended claims.

Further, the purpose of any abstract of this specification is to enable the U.S. Patent and Trademark Office, the public generally, and especially the scientists, engineers, and practitioners in the art who are not familiar with patent or legal terms or phraseology, to determine quickly from a cursory inspection the nature and essence of the technical disclosure of the application. Any such abstract is neither intended to define the invention of the application, which is measured by the claims, nor is it intended to be limiting, as to the scope of the invention in any way.

What is claimed is:

1. A traffic hazard warning apparatus, comprising:
at least one sensor engaged with a user or garment worn by said user;
said sensor in operative engagement with a processing circuit;
said sensor communicating a signal to said processing circuit, said signal being generated relative to light or sound from a vehicle approaching said user;
at least one user alarm positioned on said user or said garment, said alarm in communication with said processing circuit; and
said user alarm activated by said processing circuit to warn said user of danger from said vehicle when said signal from said sensor surpasses a predetermined threshold level, whereby said user is warned of danger from an approaching vehicle.

2. The traffic hazard warning apparatus of claim 1, additionally comprising:
said alarm in one or a combination of alarms from a group including, a visually discernable alarm to said user, a haptic alarm in communication with the body of said user, and a sonic alarm which may be heard by said user.

3. The traffic hazard warning apparatus of claim 2 wherein said alarm is a said haptic alarm formed by a bracelet wearable by said user, said bracelet having a buzzer thereon.

4. The traffic hazard warning apparatus of claim 1, additionally comprising:
a passive light-emitting area positioned on said garment; and
said light-emitting area formed of reflective material which illuminates when struck by headlights from said vehicle.

5. The traffic hazard warning apparatus of claim 2, additionally comprising:
a passive light-emitting area positioned on said garment; and
said light-emitting area formed of reflective material which illuminates when struck by headlights from said vehicle.

6. The traffic hazard warning apparatus of claim 3, additionally comprising:
a passive light-emitting area positioned on said garment; and
said light-emitting area formed of reflective material which illuminates when struck by headlights from said vehicle.

7. The traffic hazard warning apparatus of claim 1, additionally comprising:
an active light-emitting area positioned on said garment;
said active light-emitting area producing light therefrom when connected to an electric power source; and
said processing circuit configured to connect said active light-emitting area to said power source when said signal from said sensor surpasses said predetermined threshold level.

8. The traffic hazard warning apparatus of claim 2, additionally comprising:
an active light-emitting area positioned on said garment;
said active light-emitting area producing light therefrom when connected to an electric power source; and
said processing circuit configured to connect said active light-emitting area to said power source when said signal from said sensor surpasses said predetermined threshold level.

9. The traffic hazard warning apparatus of claim 3, additionally comprising:
an active light-emitting area positioned on said garment;
said active light-emitting area producing light therefrom when connected to an electric power source; and
said processing circuit configured to connect said active light-emitting area to said power source when said signal from said sensor surpasses said predetermined threshold level.

10. The traffic hazard warning apparatus of claim 4, additionally comprising:
an active light-emitting area positioned on said garment;
said active light-emitting area producing light therefrom when connected to an electric power source; and
said processing circuit configured to connect said active light-emitting area to said power source when said signal from said sensor surpasses said predetermined threshold level.

11. The traffic hazard warning apparatus of claim 5, additionally comprising:
an active light-emitting area positioned on said garment;
said active light-emitting area producing light therefrom when connected to an electric power source; and
said processing circuit configured to connect said active light-emitting area to said power source when said signal from said sensor surpasses said predetermined threshold level.

12. The traffic hazard warning apparatus of claim 6, additionally comprising:
an active light-emitting area positioned on said garment;
said active light-emitting area producing light therefrom when connected to an electric power source; and
said processing circuit configured to connect said active light-emitting area to said power source when said signal from said sensor surpasses said predetermined threshold level.

13. The traffic hazard warning apparatus of claim 7, additionally comprising:
said active light-emitting area positioned on said garment having adjacent sections; and
said active light-emitting area producing said light from each said section sequentially to form a directional beacon for said vehicle.

14. The traffic hazard warning apparatus of claim 8, additionally comprising:
said active light-emitting area positioned on said garment having adjacent sections; and
said active light-emitting area producing said light from each said section sequentially to form a directional beacon for said vehicle.

15. The traffic hazard warning apparatus of claim 9, additionally comprising:
said active light-emitting area positioned on said garment having adjacent sections; and
said active light-emitting area producing said light from each said section sequentially to form a directional beacon for said vehicle.

16. The traffic hazard warning apparatus of claim 10, additionally comprising:
said active light-emitting area positioned on said garment having adjacent sections; and
said active light-emitting area producing said light from each said section sequentially to form a directional beacon for said vehicle.

17. The traffic hazard warning apparatus of claim 11, additionally comprising:
said active light-emitting area positioned on said garment having adjacent sections; and
said active light-emitting area producing said light from each said section sequentially to form a directional beacon for said vehicle.

18. The traffic hazard warning apparatus of claim 12, additionally comprising:
said active light emitting area positioned on said garment having adjacent sections; and
said active light-emitting area producing said light from each said section sequentially to form a directional beacon for said vehicle.
